(19) United States
(12) Patent Application Publication
(10) Pub. No.: US 2004/0013823 A1
(43) Pub. Date: Jan. 22, 2004

(54) Waterproofed and reinforced plastic object and method for making same

(76) Inventors: Claude Dehennau, Waterloo (BE); Jean De Canniere, Brussels (BE)

Correspondence Address: LARSON & TAYLOR, PLC, 1199 NORTH FAIRFAX STREET, SUITE 900, ALEXANDRIA, VA, 22314, US

(21) Appl. No.: 10/311,221

(22) PCT Filed: Jun. 21, 2001
(86) PCT No.: PCT/EP01/07062

(30) Foreign Application Priority Data
Jun. 22, 2000 (FR) 00/08110

(51) Int. Cl. C09K 19/00

(52) U.S. Cl. 428/1.61; 428/1.1

(57) ABSTRACT

Plastic object, in particular a pipe, made impermeable by a thin layer based on a liquid-crystal polymer (LCP) in the form of tapes wound on top of its external surface and mechanically reinforced by an outer layer comprising an oriented polymer.

Process for manufacturing such a pipe by winding LCP tapes and depositing an outer reinforcement layer.

The present invention relates to a plastic object reinforced and made impermeable in order to withstand various stresses.

More particularly, it relates to the operation of making plastic objects, especially hollow objects, impermeable to gases and to aqueous or organic liquids that may possibly contain dissolved substances, and to their mechanical reinforcement in order to give them strength properties superior to those that the objects simply made impermeable have naturally.

Various techniques are known for giving barrier properties to surfaces of plastic objects. Two different approaches have led to the proposal of solutions that have been employed in processes for manufacturing these objects. The first is based on the surface treatment of the object by means of a plasma or a chemical reactant, such as sulphur dioxide or gaseous fluorine that are capable of modifying the molecules of the plastic lying on the surface of the object. Another approach consists in inserting, into the thickness of the plastic of which the object is made, a layer comprising a particular material, often itself thermoplastic, having a barrier property with respect to one or more gases or liquids. In the latter case, a wide range of coextrusion processing techniques have been used.

As barrier material, it is common practice to use fluoropolymers, polyamides, polyacrylonitriles, polyesters and polyvinylidene halides. A material commonly employed is an ethylene/vinyl alcohol copolymer (EVOH). However, these materials are never totally effective as a barrier for all types of gas or liquid with which they are brought into contact. This is why barrier products more effective that those mentioned above have been sought. Liquid-crystal polymers (LCPs) have been proposed so as to be able to achieve almost total impermeability for an extended range of gases and liquids.

Also known is a technique for producing pipes whose plastic is biaxially oriented in the directions parallel and perpendicular to the axis of the pipe, so as to give it improved mechanical strength properties. However, the biaxial orientation operation can be carried out only on the pipe preformed by extrusion, making the process a batch process and increasing the cost thereof. Moreover, to maintain the biaxial orientation of the material during the fitting of couplers means that particular precautions, involving the use of many special couplers, have to be taken. Moreover, the reinforcement obtained using this technique is above all effective in the longitudinal direction, and only very partially solves the problem of resistance to the radial forces that represent in some applications, for example the transportation of pressurized fluids, the predominant stresses. Hitherto, the endeavours to make the biaxial orientation process continuous have not yet fully borne their fruit because of the technological constraints and the substantial cost burden that they entail—the increase in strength obtained is still insufficient.

Another reinforcement approach has been to place reinforcements on plastic pipes, such as for example a continuous winding of fibres (for example glass fibres) impregnated with a thermoplastic or thermosetting resin (COFITS). However, this approach is not without defect either, as these windings are generally brittle and greatly increase the density of the resulting reinforced pipe and its cost, especially production cost. Moreover, the effectiveness of these reinforcements does not always remain constant over time and it is often difficult to recycle scrap pipe being manufactured or scrap pipes at the end of their life, because of the incorporation into the polymer of the pipe of foreign matter difficult to separate.

International Patent Application WO 99/57474 discloses a composite pipe for transporting hot and cold water, comprising a basic pipe made of crosslinked polyethylene and an LCP barrier layer. A variant of this pipe furthermore includes an external layer acting both as a means of mechanical protection and as a barrier against oxygen diffusion.

However, such structures are relatively weak and furthermore have a poor creep resistance under prolonged load.

It is an object of the invention to alleviate these drawbacks and to provide a plastic object which includes a thin LCP film and is very resistant to the mechanical stresses coming from the environment in which it is placed, without an appreciable reduction in its strength during its lifetime.

For this purpose, the invention relates to a plastic object, reinforced and made impermeable, characterized in that it comprises a base structure, a thin impermeable layer based on a liquid-crystal polymer (LCP) in the form of tapes wound on top of its external surface, and another outer layer for reinforcement, comprising at least one oriented polymer.

The invention relates to plastic objects, that is to say objects that are solid under ambient conditions and comprising at least one polymeric material, in particular a thermoplastic polymer. These objects may be of any size and shape.

In particular, the invention relates to hollow objects, that is to say objects having at least one concave surface defining a volume that is closed or otherwise. Examples of such hollow bodies are bottles and tanks intended to contain a gas and/or a liquid.

Other types of hollow bodies to which the invention advantageously applies are hoses and pipes, such as for example water pipes, pipes used in chemical engineering applications, plastic hoses for medical use, and air or fuel feed lines for motor-vehicle engines.

The invention is particularly well suited in the case of large-diameter (at least 30 mm, preferably at least 100 mm and particularly preferably at least 200 mm) pipes such as, for example, pipes for transporting drinking water.

The term “plastic” is understood to mean any material comprising at least one polymer made of synthetic resin.

All types of plastic may be suitable. Particularly suitable plastics belong to the thermoplastics category.

The term “thermoplastic” is understood to mean any thermoplastic polymer, including thermoplastic elastomers, and blends thereof. The term “polymer” is understood to mean both homopolymers and copolymers (especially binary or ternary ones). Without being limited thereby, examples of such copolymers are: random copolymers, linear and other block copolymers, and graft copolymers.

Any type of thermoplastic polymer or copolymer whose melting point is below the decomposition temperature is suitable. Synthetic thermoplastics that have a melting range spread over at least 10° C. are particularly suitable. As examples of such materials, there will be those exhibiting polydispersity in their molecular mass.

In particular, it is possible to use polyolefins, polyvinyl halides, thermoplastic polyesters, polyketones, polyamides and copolymers thereof. A blend of polymers or copolymers may also be used, as may a blend of polymeric materials with inorganic, organic and/or natural fillers such as, for example, but not limitingly: carbon, salts and other inorganic derivatives, and natural or polymeric fibres. It is also possible to use multilayer structures consisting of stacked layers bonded together, comprising at least one of the polymers or copolymers described above.

Polyvinyl halides and polyolefins are generally preferred.

One polymer often employed is polyethylene. Excellent results have been obtained with high-density polyethylene (HDEE).

According to the invention, the object is made impermeable, that is to say capable of being able to retain certain materials in contact with its surface and of stopping the migration of these materials through its thickness. In this case, the objects according to the invention are impermeable to gases and to aqueous or organic liquids liable to come into contact with them. Among gases commonly encountered, mention may be made of air, oxygen and carbon dioxide. Among liquids, possibly including an inorganic or organic solute, encountered are water, aliphatic or alicyclic alcohols, hydrocarbons and, in particular, petrol fuels for internal-combustion engines and diesel fuel for diesel engines. The object made impermeable is also liable to come into contact with several liquids and/or gases as a mixture.

According to the invention, the object comprises a base structure, that is to say a structure comprising a polymeric base material composition. The base material composition is a polymeric composition that represents at least 60% by weight of the total weight of the reinforced object.

The term “reinforced object” is understood to mean an object whose intrinsic mechanical properties of the base structure constituting it are modified by the presence of a layer of additional material that is separate from the base structure and, because of its presence, provides further mechanical strength.

The term “liquid-crystal polymer” (LCP) is understood to mean a polymer whose molecules are in a fluid and ordered state within a temperature range intermediate between those corresponding to the solid state and those corresponding to the completely disordered melt state (thermotropic polymer) or else a polymer capable of being in the ordered state in solution (lyotropic polymer). In general, LCPs have anisotropic and/or birefringent properties in the melt state.

Preferably, the LCP used in the process according to the invention belongs to the class of thermotropic polymers. Such polymers generally comprise elongate chains in which rigid units and flexible units alternate.

As examples of thermotropic LCP polymers, mention may be made of p-hydroxybenzoic acid/6-hydroxy-2-naphthoic acid copolyesters known by the brand name VECTRA® and p-hydroxybenzoic acid/terephthalic acid/4,4′-biphenol copolyesters known under the brand name XYDAR®.

Examples of such polymers are given in the work “Encyclopedia of Polymer Science and Engineering”, published by John Wiley & Sons, New York, 1987, Vol. 9, pages 1 to 61 and in particular the polyesters in Table 12 (pages 50 and 51) and Table 13 (page 52).

The term “thin LCP-based layer” is understood to mean a film comprising an LCP, the width of which does not exceed 0.5 m and the thickness of which does not exceed 0.25 mm and preferably does not exceed 0.1 mm. Very particularly preferred are films having a thickness of at least 0.01 mm and better still 0.005 mm.

In these tapes, the LCP may be the sole constituent. These tapes may also consist of a blend of at least two different LCPs. Alternatively, the tapes may also consist of an alloy of an LCP with other polymers, in which the LCP forms the continuous phase.

According to the invention, the thin LCP-based layer consists of tapes comprising this LCP that are wound around the object to be made impermeable.

These tapes may, for example, be wound around the object as a single thickness of tapes which are partially overlapped over at most 10% of their area. Alternatively, and preferably, they may also not overlap and be placed instead with touching turns around the object to be made impermeable, that is to say in such a way that the successive turns are deposited against the preceding turn, and do not overlap it.

When the object made impermeable has a symmetry of revolution, the LCP tapes may advantageously be wound in a direction that makes an acute angle with the direction of the axis of revolution of the object. This angle may be set in such a way that, for example, taking into account the width of the LCP tape, two adjacent turns are always touching. This angle is chosen not to exceed 90°. Preferably, it does not exceed 75°. More preferably, this angle does not exceed 60°. Moreover, it is recommended that this angle must not be less that 0° and preferably not less than 10°. More preferably, this angle is not less than 20°.

Advantageously, the object made impermeable according to the invention comprises at least one thickness of wound tapes.

In certain cases, it may be beneficial for any two adjacent thicknesses of tapes to be of equal angle but of opposite sign with respect to a direction perpendicular to the direction of the axis of symmetry of revolution of the object made impermeable.

According to the invention, the thin LCP-based layer is wound on top of the external surface of the object to be made impermeable. By this it should be understood that, in the case of hollow objects, the thin layer is wound on the convex side of the object. In the case of a solid object, it is wound around the periphery of the object, on that surface which separates it from the external world.

The object reinforced and made impermeable according to the invention also includes another outer object for reinforcement.

This other reinforcement layer is placed on top of the thin LCP-based layer. Its function is to provide the object, reinforced and made impermeable, with further mechanical strength.

According to the invention, the reinforcement layer comprises at least one oriented polymer. It may comprise a single oriented polymer. Alternatively, it may also comprise a blend of several polymers and possibly of non-polymeric additives, at least one of the polymers of which is oriented. The polymer may be any thermoplastic polymer which can be present in the reinforcement layer in oriented form, that is to say having at least 20% by weight of the molecular chains of which it is composed lying along at least any one same direction. As oriented polymer, it is possible to choose any type of thermoplastic polymer that lends itself well to its molecular chains being oriented. If several oriented polymers are present, they may share the same orientation direction. Alternatively, they may be oriented in several different directions. Preferably, when the object is of elongate shape in one particular direction, at least one of the polymers is oriented in a direction between +20° and −20° with respect to a direction perpendicular to this particular direction.

The oriented polymer of the tapes may be of the same kind as one of the polymers within the object, especially within the base structure thereof. On the other hand, it may also be a polymer not present in this object if the operating conditions require it or are somewhat incompatible with the use of an identical polymer.

In the object reinforced and made impermeable according to the invention, the tapes forming the thin LCP-based layer also advantageously have an oriented molecular structure.

This structure may be a uniaxially oriented structure, that is to say one oriented in only a single direction. In this case, the direction of orientation is generally that of the length of the wound tape forming the thin layer.

Alternatively, the structure of the tapes forming this thin layer may also be multiaxially oriented, that is to say oriented in at least two directions. Such a structure exists, for example, in the LCP-based tapes that have been manufactured by extrusion through a die counter-rotating with respect to the rotation of the extrusion screw.

In one particular embodiment of the object according to the invention, at least one adhesive layer is inserted between any two adjacent layers of the structure.

The term “adhesive layer” is understood to mean any layer comprising an adhesive compatible with the constituents of at least one of the adjacent layers. The adhesive most commonly employed is generally a polymer adhesive in the form of a functionalized polyolefin. The term “functionalized polyolefin” is understood to mean any polyolefin comprising, apart form the units derived from olefins, functional monomeric units. These may be incorporated either into the main chain of the polyolefin or into its side chains. They may also be incorporated directly into the backbone of these main and side chains, for example by copolymerizing one or more functional monomers with the olefin monomer or monomers, or else they may result from grafting one or more functional monomers onto the said chains, after the polyolefin has been manufactured. Several functionalized polyolefins may also be used as a blend.

The functional monomeric units of the functionalized polyolefin may be chosen from carboxylic acids, dicarboxylic acids, anhydrides corresponding to these diacids, and epoxy groups. These monomeric units generally derive from the copolymerization or the grafting of at least one unsaturated monomer possessing the same functional groups. Examples of monomers that can be used are, but not limitingly, acrylic acid, methacrylic acid, maleic acid, fumaric acid, itaconic acid, maleic anhydride, fumaric anhydride, itaconic anhydride and vinyl ethers and esters. Preferably, the functional monomeric units derive from the copolymerization or the grafting of maleic anhydride.

Further beneficial adhesives that may also be employed are copolymers based on ethylene (E) and glycidyl methacrylate (GMA) and E/MA/GMA, E/BA/GMA and E/VAC/GMA terpolymers in which MA and BA symbolize methyl acrylates and butyl acrylates respectively and VAC symbolizes vinyl acetate.

The invention is well suited to an object having a base structure in the form of a hollow plastic pipe obtained by extrusion.

The extrusion takes place in a screw machine which mixes and forces the molten plastic through a die.

According to another embodiment of the object according to the invention, the reinforcement layer is chosen from a layer formed from tapes of oriented polymer and a continuous layer of oriented polymer. In the first case, the tapes are wound around the object made impermeable, in the same way as the tapes making up the LCP-based layer that were described above.

According to a final preferred embodiment of the object according to the invention, it furthermore includes an additional outer layer for finishing, which itself comprises a polymer of the same kind as that of the base structure. This polymer is often chosen from polyvinyl halides and polyolefins. The functions of the finishing layer are especially to protect the subjacent layers and to provide the object with a precisely controlled outer shape.

Sometimes, if it is desired to join a number of objects together, it also allows couplers to be fitted and attached more easily. The latter function is particularly useful when the object is a pipe.

The thickness of an external finishing layer is often at least 0.5 mm. In general, it does not exceed 2 mm.

An example of a preferred structure is the following:

A/B/C/D/E/F

in which:

A is an extruded thermoplastic polymer, for example high-density polyethylene (HDPE);

B is an adhesive layer;

C is a thin LCP-based impermeabilization layer in the form of tapes wound with touching turns;

D is another adhesive layer;

E is a reinforcement layer in the form of tapes of oriented thermoplastic; and

F is an external finishing layer made of thermoplastic.

An alternative structure consists in inserting, into the above structure, an additional protective layer acting as a thermal screen between the layers E and F. This alternative avoids the low degrees of orientation of the reinforcement layer that may occur when fitting the finishing layer, by thermal relaxation of the molecular orientations of the reinforcement layer.

The invention also relates to a process for manufacturing an impermeable and reinforced pipe, characterized in that it comprises at least the following steps, in the order indicated:

extrusion of a thermoplastic pipe;

winding onto the pipe of at least one layer of thin tape comprising an LCP as impermeabilization layer; and

deposition of an outer reinforcement layer.

The definitions of the terms employed here for the process are mutatis mutandis the same as those mentioned above in regard to the object.

When the structure of the reinforcement layer is multiaxially oriented, it is better suited for processing using the coextrusion technique.

According to the invention, the deposition of the outer reinforcement layer is carried out using the method of coextruding an oriented polymer layer during extrusion of the thermoplastic pipe.

Alternatively, this deposition may also be carried out by winding at least two crossed layers of oriented polymer tapes.

According to one particular method of implementing the process according to the invention, at least the tapes of the impermeabilization layer or the reinforcement layer are coated by means of an adhesive composition before they are used on the pipe.

An alternative process consists in coating the base structure with an adhesive composition. It is also possible to combine the coating of at least one impermeabilization or reinforcement layer by means of an adhesive composition with the coating of the base structure. If the base structure and/or several layers are coated, the adhesive composition used may be different for the base structure and/or each of the layers. Alternatively, the adhesive composition may also be similar in the case of the base structure and/or in the case of all the other layers when its compatibility with each of them does not pose a problem.

According to another particular method of implementation according to the invention, the pipe provided with its reinforcement layer is covered with an additional outer finishing layer comprising a polymer chosen from polyvinyl halides and polyolefins.

The nature of the employed and the definition of the outer finishing layer are similar to those already described above in regard to the object.

1. Plastic object, reinforced and made impermeable, characterized in that it comprises a base structure, a thin impermeable layer based on a liquid-crystal polymer (LCP) in the form of tapes wound on top of its external surface, and another outer layer for reinforcement, comprising at least one oriented polymer.

2. Object according to the preceding claim, characterized in that the thin LCP-based layer has a molecular structure chosen from uniaxially and multiaxially oriented structures.

3. Object according to either of the preceding claims, characterized in that at least one adhesive layer is inserted between any two adjacent layers of the structure.

4. Object according to any one of the preceding claims, characterized in that the base structure is a hollow plastic pipe obtained by extrusion.

5. Object according to any one of the preceding claims, characterized in that the reinforcement layer is chosen from a layer formed from tapes of oriented polymer and a continuous layer of oriented polymer.

6. Object according to any one of the preceding claims, characterized in that it furthermore includes an additional outer layer for finishing, which comprises a polymer of the same kind as that of the base structure.

7. Process for manufacturing an impermeable and mechanically reinforced pipe, characterized in that it comprises at least the following steps, in the order indicated:
extrusion of a thermoplastic pipe;
winding onto the pipe of at least one layer of thin tape comprising an LCP as impermeabilization layer; and
deposition of an outer reinforcement layer.

8. Process according to claim 7, characterized in that the deposition of the reinforcement layer is carried out using the method of coextruding an oriented polymer layer or by winding at least two crossed layers of oriented polymer tapes.

9. Process according to either of claims 7 and 8, characterized in that at least the base structure and/or the tapes of the impermeabilization layer or the reinforcement layer are coated by means of an adhesive composition before they are used.

10. Process according to any one of claims 7 to 9, characterized in that the pipe provided with its impermeabilization layer and its reinforcement layer is covered with an additional outer finishing layer comprising a polymer chosen from polyvinyl halides and polyolefins.
